(19) United States
(12) Patent Application Publication
(10) Pub. No.: US 2011/0262174 A1
(43) Pub. Date: Oct. 27, 2011

(54) IMAGE FORMING APPARATUS FOR PREVENTING SCATTER OF TONER FROM DEVELOPING DEVICE

(75) Inventor: Eiji GUMBE, Kanagawa (JP)

(73) Assignees: Toshiba Tec Kabushiki Kaisha, Tokyo (JP); Kabushiki Kaisha Toshiba, Tokyo (JP)

(21) Appl. No.: 13/040,219

(22) Filed: Mar. 3, 2011

Related U.S. Application Data
(60) Provisional application No. 61/326,583, filed on Apr. 21, 2010.

(51) Int. Cl. G03G 21/00; G03G 15/09

(52) U.S. Cl. 399/92; 399/99; 399/277; 399/358; 399/93

(57) ABSTRACT

A developing device includes: a developing roller that faces an image carrier at a development position; a housing that supports the developing roller, supplies a developer to the developing roller and includes an opening portion formed in a wall surface of the housing; and a pipe that communicates with the opening portion.

### CROSS-REFERENCE TO RELATED APPLICATION

This application is based upon and claims the benefit of priority from Provisional U.S. Application 61/326,583 filed on Apr. 21, 2010, the entire contents of which are incorporated herein by reference.

### FIELD

Embodiments described herein relate to a developing device that conducts development with the use of a developing roller of a magnetic brush type in a copying machine, a printer or the like.

### BACKGROUND

There is a developing device that conducts development with a developing roller of a magnetic brush type in a copying machine, a printer or the like.

In the developing device using the developing roller, an internal pressure within a housing increases with rotation of the developing roller. There is a risk that floating toner within the, housing scatters around the housing, resulting in contamination.

For that reason, it is desirable to develop the developing device for preventing floating toner within the housing from scattering during rotation of the developing roller.

### BRIEF DESCRIPTION OF THE DRAWINGS

FIG. 1 is a configuration diagram schematically illustrating a main portion of a color printer according to a first embodiment;

FIG. 2 is an explanation diagram schematically illustrating a recovery device according to the first embodiment;

FIG. 3 is a perspective view schematically illustrating the recovery device according to the first embodiment, a part of which is omitted;

FIG. 4 is a configuration diagram schematically illustrating an image forming station according to the first embodiment;

FIG. 5 is a perspective view schematically illustrating the image forming station from which a decompression chamber cover and a decompression duct are removed, and partially of a recovered toner transport unit, according to the first embodiment;

FIG. 6 is an explanation diagram schematically illustrating a magnetic field line around the developing roller and a flow of air resulting from rotation of the developing roller, according to the first embodiment;

FIG. 7 is a perspective view schematically illustrating the image forming station and partially of the recovered toner transport unit according to the first embodiment;

FIG. 8 is an illustrative diagram schematically illustrating the image forming station and partially of the recovered toner transport unit, viewed from a front side, according to the first embodiment;

FIG. 9 is a perspective view schematically illustrating the decompression duct according to the first embodiment;

FIG. 10 is a perspective view schematically illustrating a tube which is another example of a pipe in the first embodiment;

FIG. 11 is a configuration diagram schematically illustrating a main portion of a color printer according to a second embodiment; and

FIG. 12 is a perspective view schematically illustrating an image forming station and partially of a recovered toner transport unit according to the second embodiment.

### DETAILED DESCRIPTION

According to embodiments, a developing device includes: a developing roller that faces an image carrier at a development position; a housing that supports the developing roller, supplies a developer to the developing roller and includes an opening portion formed in a wall surface of the housing; and a pipe that communicates with the opening portion and is connected to a toner recovery unit.

Hereinafter, embodiments will be described.

### First Embodiment

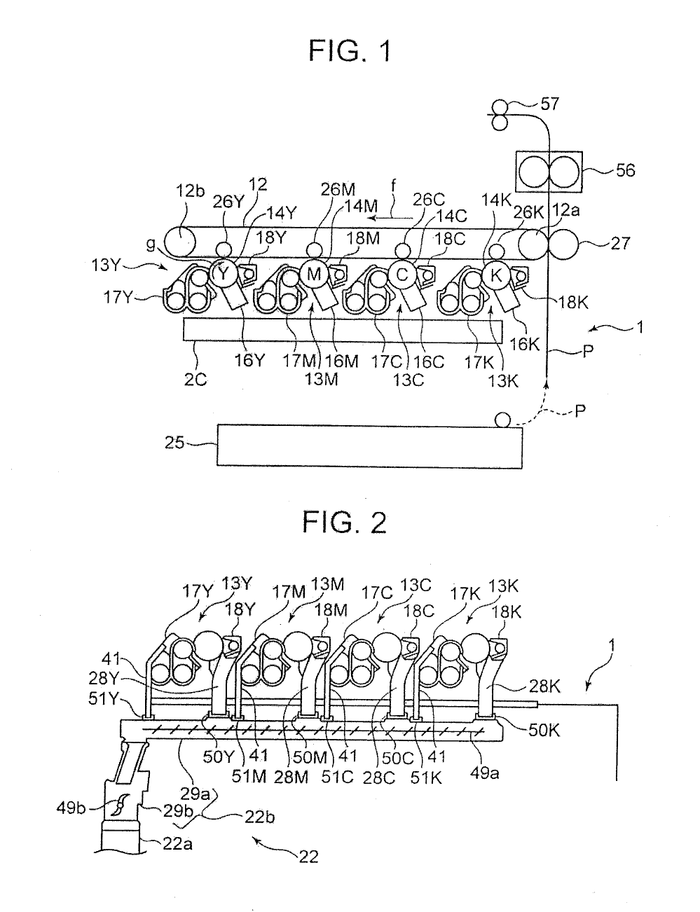

FIG. 1 illustrates a main portion of a 4-drum tandem color printer 1 that is an image forming apparatus according to a first embodiment. The color printer 1 includes four sets of image forming stations 13Y, 13M, 13C, and 13K, which configure image formation units arranged in parallel along a lower side of a transfer belt 12. The image forming stations 13Y, 13M, 13C, and 13K include photoreceptor drums 14Y, 14M, 14C, and 14K, respectively. The image forming stations 13Y, 13M, 13C, and 13K form toner images of Y (yellow), M (magenta), C (cyan), and K (black) on the photoreceptor drums 14Y, 14M, 14C, and 14K, respectively.

The image forming stations 13Y, 13M, 13C, and 13K include chargers 16Y, 16M, 16C, and 16K, developing devices 17Y, 17M, 17C, and 17K, and photoreceptor cleaners 18Y, 18M, 18C, and 18K around the photoreceptor drums 14Y, 14M, 14C, and 14K, respectively, which rotate in a direction of an arrow g. For example, each of the image forming stations 13Y, 13M, 13C, and 13K is unitized, and integrally detachably attached to the color printer 1. Alternatively, those four image forming stations 13Y, 13M, 13C, and 13K may be unitized so that those four image forming stations 13Y, 13M, 13C, and 13K are integrally detachably attached to the color printer 1.

The color printer 1 includes a laser exposure device 20 that configures the image formation unit. The laser exposure device 20 irradiates the photoreceptor drums 14Y, 14M, 14C, and 14K between the chargers 16Y, 16M, 16C, and 16K and the developing devices 17Y, 17M, 17C, and 17K with laser beams corresponding to the respective colors to form electrostatic latent images on the photoreceptor drums 14Y, 14M, 14C, and 14K, respectively. The developing devices 17Y, 17M, 17C, and 17K develop the electrostatic latent images formed on the photoreceptor drums 14Y, 14M, 14C, and 14K, respectively, to form toner images of Y (yellow), M (magenta), C (cyan), and K (black) on the photoreceptor drums 14Y, 14M, 14C, and 14K, respectively.

The color printer 1 includes a backup roller 12a and a driven roller 12b between which the transfer belt 12 extends, and allows the transfer belt 12 to travel in a direction of an arrow f. The color printer 1 includes primary transfer rollers 26Y, 26M, 26C, and 26K at positions facing the photoreceptor drums 14Y, 14M, 14C, and 14K through the transfer belt 12, respectively. The primary transfer rollers 26Y, 26M, 26C, and 26K primarily transfer the toner images on the photoreceptor drums 14Y, 14M, 14C and 14K to the transfer belt 12 superimpose on top of another. The photoreceptor cleaners 18Y, 18M, 18C, and 18K remove toner remaining on the photoreceptor drums 14Y, 14M, 14C, and 14K, respectively, after the primary transfer and recover the removed toner.

The color printer 1 includes a secondary transfer roller 27 at a secondary transfer position facing the backup roller 12a through the transfer belt 12. The color printer 1 secondarily transfers the toner images on the transfer belt 12 to a sheet P fed from a sheet feed unit 25 at a nip between the transfer belt 12 and the secondary transfer roller 27 in a lump. The color printer 1 includes a fixing device 56 and a sheet discharge roller 57 downstream of the secondary transfer roller 27 along a transport direction of the sheet P. The color printer 1 fixes the toner image on the sheet P through the fixing device 56, and discharges the sheet P through the sheet discharge roller 57.

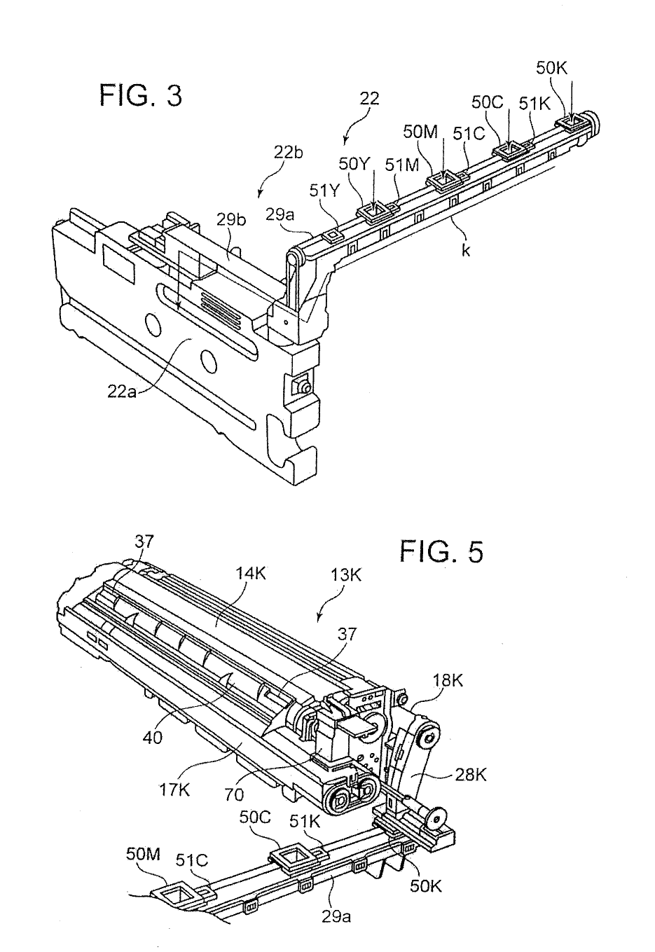

As illustrated in FIGS. 2 and 3, the color printer 1 includes a recovery device 22 that is a toner recovery unit. The recovery device 22 includes a waste toner box 22a that is a recovery box for containing waste toner which is a used developer therein. The recovery device 22 includes a recovered toner transport unit 22b that is disposed at a front side of the color printer 1, and transports the waste toner recovered by the photoreceptor cleaners 18Y, 18M, 18C, and 18K in a direction of the waste toner box 22a located at a side of the color printer 1.

The recovered toner transport unit 22b includes drop transport units 28Y, 27M, 28C, and 28K that are connected to the photoreceptor cleaners 18Y, 18M, 18C, and 18K, respectively, and drop and transport the waste toner from the, photoreceptor cleaners 18Y, 18M, 18C, and 18K, respectively. The recovered toner transport unit 22b includes a first horizontal transport unit 29a and a second horizontal transport unit 29b. The recovered toner transport unit 22b transports the waste toner dropped from the respective drop transport units 28Y, 28M, 28C, and 28K by augers 49a and 49b in a direction of an arrow k, and drops on the center of the waste toner box 22a.

The first horizontal transport unit 29a includes first connection portions 50Y, 50M, 50C, and 50K connected with the drop transport units 28Y, 28M, 28C, and 28K. Further, the first horizontal transport unit 29a includes second connection portions 51Y, 51M, 51C, and 51K connected with a decompression duct 41 which will be described later. The first connection portions 50Y, 50M, 50C, and 50K, and the second connection portions 51Y, 51M, 51C, and 51K are made of filter urethane foam of continuous foam.

The toner recovery unit is not limited to the recovery device 22 that recovers the waste toner recovered from the photoreceptor drums 14Y, 14M, 14C, and 14K. The toner recovery unit may be, for example, a toner recovery unit of the waste toner recovered from the transfer belt.

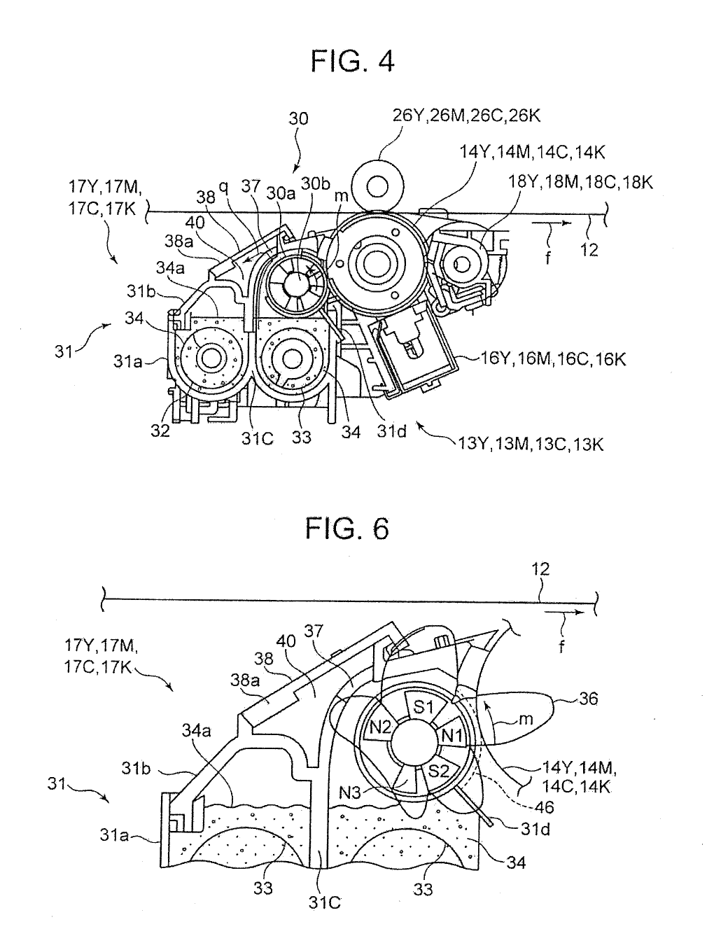

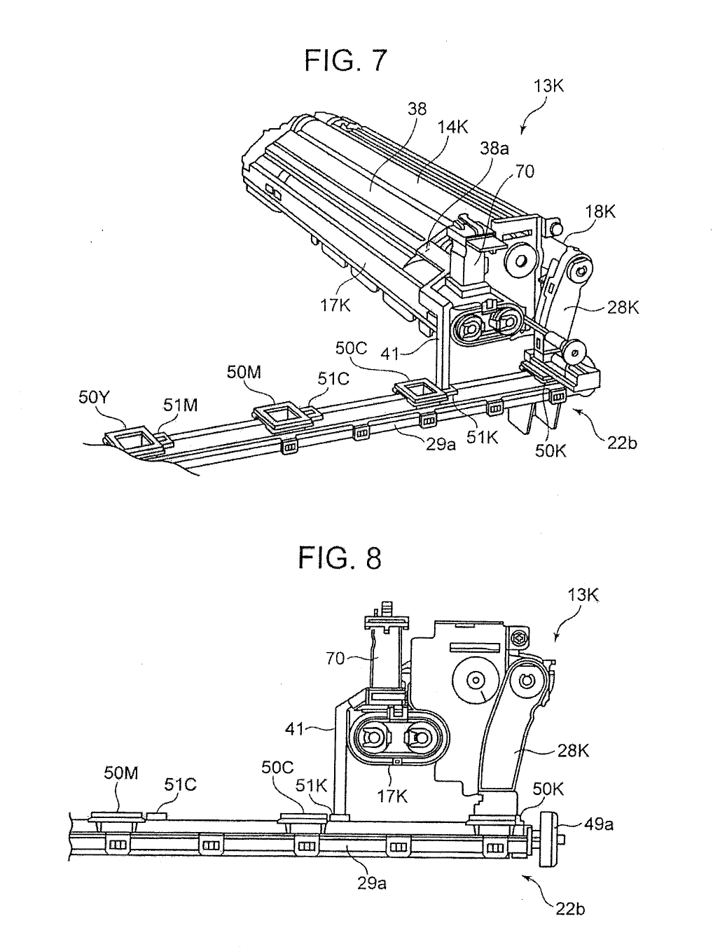

Subsequently, the developing devices 17Y, 17M, 17C, and 17K of the image forming stations 13Y, 13M, 13C, and 13K, and the recovery device 22 will described. The developing devices 17Y, 17M, 17C, and 17K in the image forming stations 13Y, 13M, 13C, and 13K are identical with each other, and therefore common symbols are used for description. As illustrated in FIGS. 4 to 9, each of the developing devices 17Y, 17M, 17C, and 17K includes a housing 31 made of, for example, resin, which supports the developing roller 30. The housing 31 includes, for example, a lower housing 31a and an upper housing 31b. The housing 31 contains a two-component developer 34 having toner and carrier, which is supplied to the developing roller 30. The housing 31 may be of a type in which the lower housing 31a and the upper housing 31b are integrated together, which are, for example, formed by aluminum extrusion.

The lower housing 31a includes a first mixer 32 and a second mixer 33 separated by a partition 31c. The first mixer 32 and the second mixer 33 agitate toner supplied from a toner supply unit 70 and the developer 34 in the housing 31, and transport the agitated one in circulation. The lower housing 31a includes a doctor 31d that uniforms a thickness of a magnetic brush 46 due to the developing roller 30.

The developing roller 30 includes a cylindrical development sleeve 30a made of nonmagnetic material such as aluminum. The development sleeve 30a rotates in a direction of an arrow m. The developing roller 30 includes a magnet roller 30b fixed to the interior of the development sleeve 30a. The magnet roller 30b has a development magnetic pole N1 of N polarity, a recovery magnetic pole S1 of S polarity, a first peeling magnetic pole N2 and a second peeling magnetic pole N3 of N polarity, and a supply magnetic pole S2 of S polarity along a rotating direction of the development sleeve 30a. The development magnetic pole N1 is at a development position facing the photoreceptor drums 14Y, 14M, 14C, and 14K. The magnet roller 30b forms a magnetic field line 36, for example, illustrated in FIG. 6, among the development magnetic pole N1, the recovery magnetic pole S1, the first peeling magnetic pole N2, the second peeling magnetic pole N3, and the supply magnetic pole S2.

The upper housing 31b includes a decompression hole 37, which is an opening portion, at both side of the development sleeve 30a in the longitudinal direction downstream of the recovery magnetic pole S1. The developing devices 17Y, 17M, 17C, and 17K include a cover 38 that covers the decompression hole 37 of the upper housing 31b. The cover 38 includes a decompression chamber 40 that is adjacent to the upper housing 31b and communicates with the decompression hole 37. The cover 38 includes a connection hole 38a at the front side. A position where the opening portion is formed is not limited. The opening portion only needs to be above an upper surface 34a of the developer within the housing in order to prevent the developer contained in the housing from overflowing from the opening portion.

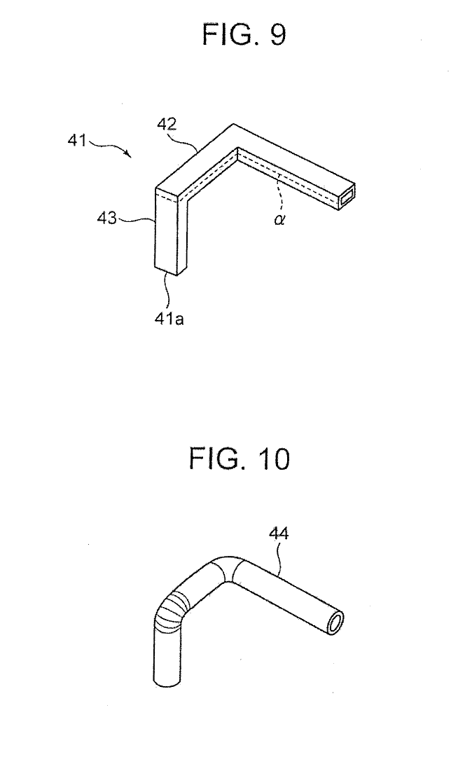

The developing devices 17Y, 17M, 17C, and 17K include a hollow decompression duct 41 which is a pipe for connecting a connection hole 38a and the first horizontal transport unit 29a. The decompression duct 41 is molded by, for example, plastic, and molded by combination of a first part 42 above a dotted line α in FIG. 9 and a second part 43 under the dotted line α. An outflow end 41a of the decompression duct 41 connected to the connection hole 38a of the developing devices 17Y, 17M, 17C, and 17K are detachably attached to the second connection portions 51Y, 51M, 51C, and 51K by respect operation of attaching or detaching the image forming stations 13Y, 13M, 13C, and 13K to the color printer 1. As another example of the pipe, a flexible hollow tube 44 made of soft plastic illustrated in FIG. 10 may be used.

When the development sleeve 30a of the developing devices 17Y, 17M, 17C, and 17K rotates in a direction of the arrow m upon starting the print operation, the developer 34 forms the magnetic brush 46 around the development sleeve 30a due to the magnetic field line 36 of the magnet roller 30b.

The development sleeve 30a attracts the developer 34 transported by the second mixer 33 to the development sleeve 30a, due to the second peeling magnetic pole N3 and the supply magnetic pole S2, to form the magnetic brush 46. The magnetic brush 46 is regulated in thickness by the doctor 31d of the upper housing 31b. The magnetic brush 46 that has passed through the doctor 31d arrives at the development magnetic pole N1 facing the photoreceptor drums 14Y, 14M, 14C, and 14K. The magnetic brush 46 supplies toner to the photoreceptor drums 14Y, 14M, 14C, and 14K by the aid of the development magnetic pole N1, and develops and visualizes an electrostatic latent image. The magnetic brush 46 that has developed the electrostatic image is recovered within the housing 31 by the recovery magnetic pole S1. Further, the magnetic brush 46 is peeled off from the developing roller 30, drops above the second mixer 33, and is recovered, between the first peeling magnetic pole N2 and the second peeling magnetic pole N3.

The magnetic brush 46 that forms magnetic chains with the rotation of the development sleeve 30a in a direction of the arrow m moves in a direction of the arrow m while attracting air. When the magnetic brush 46 that has attracted air is recovered within the housing 31 due to the recovery magnetic pole S1, a pressure within the sealed housing 31 is made higher than the atmosphere. If the developing devices 17Y, 17M, 17C, and 17K include no decompressing function, the pressure within the housing 31 increases, and air mixed with the floating toner is leaked, for example, from a slight gap between the developing roller 30 and the housing 31 bit by bit.

The housing 31 has the decompression hole 37, and has the decompressing function. When the internal pressure within the housing 31 increases, an air flow is created within the housing 31 in a direction of an arrow q toward the decompression hole 37 direction. The air mixed with the floating toner occurring within the housing 31 passes through the decompression hole 37 located at the position facing the downstream of the recovery magnetic pole Sl, and enters the decompression chamber 40, due to the air flow in the direction of the arrow q. The air mixed with the floating toner, which has entered the decompression chamber 40, further passes through the decompression duct 41 from the connection hole 38a of the cover 38, and is transported to the first horizontal transport unit 29a.

The floating toner transported to the first horizontal transport unit 29a from the decompression duct 41 is recovered in the waste toner box 22a together with the waste toner recovered by the photoreceptor cleaners 18Y, 18M, 18C, and 18K. Accordingly, even if the pressure within the housing 31 is made higher than the atmosphere due to the rotation of the development sleeve 30a in a direction of the arrow m, there is no risk that the air mixed with the floating toner is leaked from the developing devices 17Y, 17M, 17C, and 17K.

According to the first embodiment, the cover 38 of the decompression chamber 40 that communicates with the decompression hole 37 of the housing 31 is connected with the decompression duct 41 connected to the recovery device 22. The air mixed with the floating toner within the housing 31 flows into the recovery device 22 through the decompression duct 41. The air is prevented from being leaked from the gap between the developing roller 30 and the housing 31 with the increased pressure within the housing 31, and the floating toner mixed in the air is prevented from scattering to the external. Since the floating toner within the housing 31 is recovered in the recovery device 22 together with the waste toner, there is no need to provide a dust collecting filter to the developing devices 17Y, 17M, 17C, and 17K. The developing devices 17Y, 17M, 17C, and 17K require no maintenance such as replacement of the dust collecting filter.

### Second Embodiment

Subsequently, a second embodiment will be described. Since the second embodiment is different in the structure of the toner recovery unit from the above first embodiment, a connection target of the decompression duct is different from the first embodiment. In the second embodiment, the same configurations as those described in the above first embodiment are denoted by identical symbols, and a detailed description thereof will be omitted. In the second embodiment, the decompression duct is connected to the toner box.

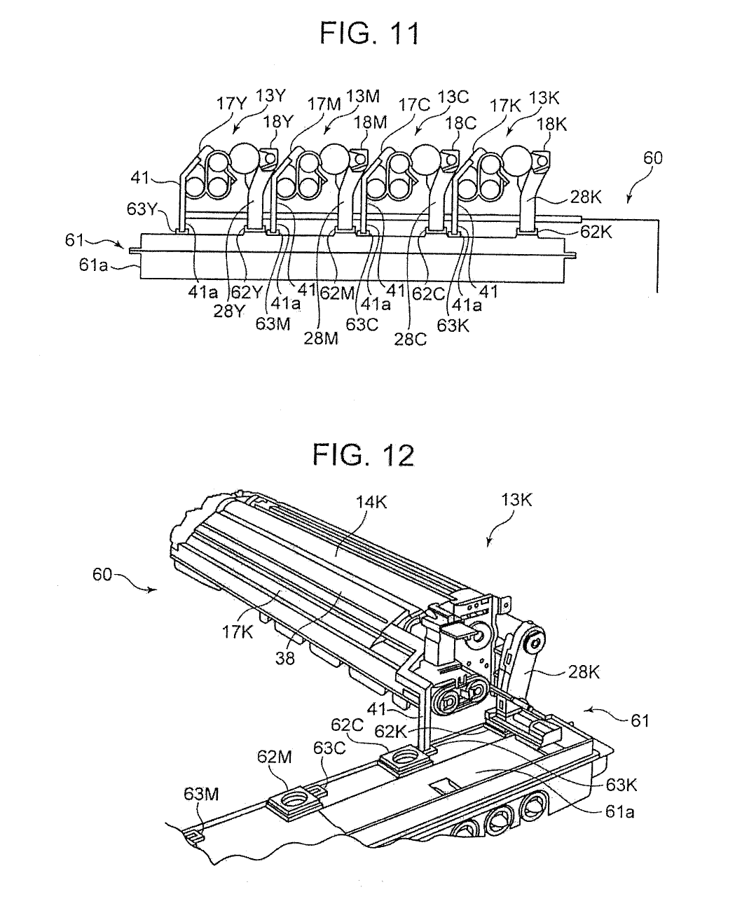

In the second embodiment, a color printer 60 employs a recovery device 61 including a waste toner box 61a at a front of the color printer 60 as the toner recovery unit as illustrated in FIGS. 11 and 12.

The recovery device 61 of the four-drum tandem color printer 60 includes the drop transport units 28Y, 28M, 28C, and 28K that drop and transport the waste toner recovered by the respective photoreceptor cleaners 18Y, 18M, 18C, and 18K, and a waste toner box 61a that contains the waste toner directly from the respective drop transport units 28Y, 28M, 28C, and 28K.

The waste toner box 61a includes third connection portions 62Y, 62M, 62C, and 62K connected with the respective drop transport units 28Y, 28M, 28C, and 28K, respectively. Further, the waste toner box 61a includes fourth connection portions 63Y, 63M, 63C, and 63K connected with the decompression duct 41. The third connection portions 62Y, 62M, 62C, and 62K, and the fourth connection portions 63Y, 63M, 63C, and 63K are made of filter urethane foam of continuous foam.

The outflow end 41a of the decompression duct 41 are detachably attached to the respective fourth connection portions 63Y, 63M, 63C, and 63K through operation of attaching or detaching the respective image forming stations 13Y, 13M, 13C, and 13K with respect to the color printer 1.

When the development sleeve 30a of the developing devices 17Y, 17M, 17C, and 17K rotates in a direction of the arrow m upon starting the print operation to increase the internal pressure within the housing 31, the air mixed with the floating toner within the housing 31 is transported to the waste toner box 61a through the decompression hole 37, the decompression chamber 40, the connection hole 38a of the cover 38, and the decompression duct 41m, and recovered. Accordingly, even if the development sleeve 30a rotates, and the pressure within the housing 31 is made higher than the atmosphere, there is no risk that the air mixed with the floating toner is leaked from the developing devices 17Y, 17M, 17C, and 17K.

Also, since the waste toner drops directly on the waste toner box 61a from the drop transport units 28Y, 28M, 28C, and 28K, and the air flow is transported from the decompression duct 41 to the waste toner box 61a, there is a possibility that the pressure within the waste toner box 61a increases. When the pressure within the waste toner box 61a increases, the pressure is removed from the third connection portions 62Y, 62M, 62C, and 62K, and the fourth connection portions 63Y, 63M, 63C, and 63K, which are made of filter urethane foam of continuous foam.

Each of the third connection portions 62Y, 62M, 62C, and 62K, and the fourth connection portions 63Y, 63M, 63C, and 63K has a filter function, and collects the floating toner when the pressure within the waste toner box 61a is removed so as to prevent the floating toner from scattering to the external. While the waste toner and the floating toner are recovered in the waste toner box 61a, the third connection portions 62Y, 62M, 62C, and 62K, and the fourth connection portions 63Y, 63M, 63C, and 63K are clogged. If the waste toner box 61a becomes full, the waste toner box 61a is replaced with a fresh one together with the third connection portions 62Y, 62M, 62C, and 62K, and the fourth connection portions 63Y, 63M, 63C, and 63K. Accordingly, the maintenance of the third connection portions 62Y, 62M, 62C, and 62K, and the fourth connection portions 63Y, 63M, 63C, and 63K are, not required. A vent hole for removing the pressure may be formed in an upper surface of the waste toner box, and a filter may be provided in the vent hole to collect the floating toner.

According to the second embodiment, as in the first embodiment, the air is prevented from being leaked from the gap between the developing roller 30 and the housing 31 with the increased pressure within the housing 31, and the floating toner mixed in the air is prevented from scattering to the external. Since the floating toner within the housing 31 is recovered in the recovery device 61 together with the waste toner, there is no need to provide the dust collecting filter to the developing devices 17Y, 17M, 17C, and 17K. The developing devices 17Y, 17M, 17C, and 17K require no maintenance such as replacement of the dust collecting filter.

Further, according to the second embodiment, the pressure within the waste toner box 61a is removed from the third connection portions 62Y, 62M, 62C, and 62K, and the fourth connection portions 63Y, 63M, 63C, and 63K, which are made of filter urethane foam of continuous foam so as to prevent the floating toner within the waste toner box 61a from scattering to the external.

According to at least one of the above embodiments, the air mixed with the floating toner within the housing in the developing device is made to flow into the toner recovery unit due to the decompression duct so as to prevent toner from scattering to the external of the developing device.

While certain embodiments have been described these embodiments have been presented by way of example only, and are not intended to limit the scope of the inventions. Indeed, the novel apparatus and methods described herein may be embodied in a variety of other forms: furthermore various omissions, substitutions and changes in the form of the apparatus and methods described herein may be made without departing from the spirit of the inventions. The accompanying claims and there equivalents are intended to cover such forms of modifications as would fall within the scope and spirit of the invention.

What is claimed is:

1. A developing device comprising:
a developing roller that faces an image carrier at a development position;
a housing that supports the developing roller, supplies a developer to the developing roller and includes an opening portion formed in a wall surface of the housing; and
a pipe that communicates with the opening portion and is connected to a toner recovery unit.

2. The device according to claim 1,
wherein the opening portion is formed above an upper surface of the developer which is not held by a magnetic force of the developing roller within the housing, and downstream of the development position in a rotating direction of the developing roller.

3. The device according to claim 2,
wherein the developing roller includes a development magnetic pole at the development position and includes a recovery magnetic pole and a peeling magnetic pole in series downstream of the development magnetic pole in the rotating direction of the developing roller, and
the opening portion is formed downstream of the recovery magnetic pole in the rotating direction of the developing roller.

4. The device according to claim 1, further comprising:
a decompression chamber that is adjacent to the housing and communicates with the opening portion,
wherein the pipe is connected to the decompression chamber.

5. The device according to claim 1, wherein the pipe is connected to a recovered toner transport unit of the toner recovery unit.

6. The device according to claim 1, wherein the pipe is connected to a recovery box of the toner recovery unit.

7. The device according to claim 1, wherein the pipe is formed by combination of a plurality of parts.

8. The device according to claim 1, wherein the pipe is connected to a toner recovery unit through a dust collecting filter.

9. The device according to claim 1, wherein the pipe is connected to the toner recovery unit by operation of attaching the housing at the development position, and disconnected a connection with the toner recovery unit by operation of extracting the housing from the development position.

10. An image forming apparatus, comprising:
an image carrier;
an electrostatic formation unit that forms an electrostatic latent image on the image carrier;
a developing roller that faces the image carrier at a development position and develops the electrostatic image;
a toner recovery unit that recovers used toner derived from the image carrier;
a housing that supports the developing roller, supplies a developer to the developing roller and includes an opening portion formed in a wall surface of the housing; and
pipe that communicates with the opening portion and is connected to the toner recovery unit.

11. The apparatus according to claim 10,
wherein the opening portion is formed above an upper surface of the developer which is not held by a magnetic force of the developing roller within the housing, and downstream of the development position in a rotating direction of the developing roller.

12. The apparatus according to claim 11,
wherein the developing roller includes a development magnetic pole at the development position and includes a recovery magnetic pole and a peeling magnetic pole in series downstream of the development magnetic pole in the rotating direction of the developing roller, and
the opening portion is formed downstream of the recovery magnetic pole in the rotating direction of the developing roller.

13. The apparatus according to claim 10, further comprising: a decompression chamber that is adjacent to the housing and communicates with the opening portion,
wherein the pipe is connected to the decompression chamber.

14. The apparatus according to claim 10,
wherein the toner recovery unit includes a recovery box that contains the used toner, and a recovery toner transport unit that transports the used toner derived from the image carrier to the recovery box, and
the pipe is connected to the recovered toner transport unit.

15. The apparatus according to claim 10,
wherein the toner recovery unit includes a recovery box that contains the used toner, and a recovery toner transport unit that transports the used toner derived from the image carrier to the recovery box, and
the pipe is connected to the recovery box of the toner recovery unit.

16. The apparatus according to claim 10,
wherein the pipe is formed by combination of a plurality of parts.

17. The apparatus according to claim 10, wherein the pipe is connected to the toner recovery unit through a dust collecting filter.

18. The apparatus according to claim 10, wherein the pipe is connected to the toner recovery unit by operation of attaching the housing at the development position, and disconnected a connection with the toner recovery unit by operation of extracting the housing from the development position.

19. A method of decompressing a developing device, comprising:
discharging an air flow within a housing in a rotating direction of a developing roller; and
allowing the air flow discharged from the housing to flow into a toner recovery unit.

20. The method according to claim 19,
wherein the air flow within the housing is discharged above an upper surface of the developer which is not held by a magnetic force of the developing roller within the housing, and downstream of the development position in a rotating direction of the developing roller.
